(19) United States
(12) Patent Application Publication
(10) Pub. No.: US 2009/0120292 A1
(43) Pub. Date: May 14, 2009

(54) Barrier filter high particulate entry design

(76) Inventor: John T. Foster, Allison Park, PA (US)

Correspondence Address: Joseph A. Fuchs;Rockey, Depke & Lyons, LLC, 233 S. Wacker Drive, Suite 5450, Sears Tower, Chicago, IL, 60606-6306, US

(21) Appl. No.: 11/983,920

(22) Filed: Nov. 13, 2007

(51) Int. Cl. B01D 46/00; B01D 63/00

(52) U.S. Cl. 95/286; 55/419

(57) ABSTRACT

A fabric filter (barrier filter) with an inlet design for high particle load that allows for individual compartments in a row to be isolated by closure of a sloped inlet damper by which the sloped design allows particulate during damper closure to flow to the opposing compartment hopper preventing damper failure from the accumulated weight of the particulate load.

### BACKGROUND OF THE INVENTION

1. Technical Field

The present invention provides a filtration plant for removing particulate material from high volume gas flow streams and particularly for removing smoke and ash from gas effluent from a coal fired boiler.

2. Background Art

Fabric filters (also referred to as barrier filtration) have been used for the collection of dust from industrial applications and particulate (smoke) from coal fired boiler applications for the last fifty years. A typical filter plant employing fabric filters for a 150 Megawatt coal fired boiler would utilize eight individual filtration units with 600 filter tubes in each filtration unit. Filter plants usually are of either a high particle load design or a low particle load design. Filter plants for low particle loads are suitable for use with particle flows in the typical range of 1 grain/actual cubic foot to 35 grains/actual cubic foot. High particle load filter plants are suitable for use with particle loads well above 35 grains/actual cubic foot.

FIGS. 1 and 2 show a prior art low particle load filter plant 10 where filter compartments 12 are arranged in two rows 14a,b with four filter compartments in each row such that each of the four compartments (12a1-12a4) in row 14a is respectively in alignment with one of the four compartments (12b1-12b4) in row 14b. A common inlet manifold 16 positioned between the rows 14a,b conveys a particulate laden gas flow 17 from a boiler from an inlet 19 to all of the filter compartments. Each compartment is supplied a portion of the gas flow through transversely directed and dedicated stubs 18 which are in fluid communication with the inlet manifold. Each stub 18 bears the alpha-numeric designation of the compartment it feeds (18a1-4, 18b1-4). The gas flow to each stub can be controlled by a damper such that each compartment 12a1-a4, 12b1-b4 can be individually isolated for maintenance.

FIGS. 3 and 4 show a prior art high particle load filter plant 20 having four filter compartments 22a,d each fed by a dedicated manifold 24a,d. In this embodiment, dirty gas flow is directed from a boiler (not shown) through ductwork to an optional fluid bed scrubber 26 and to a gas splitter that divides the gas flow into dedicated flow streams 28a,d. An isolation damper 30a,d is provided at an inlet 32a,d to each manifold 24a,d. FIG. 4 shows gas from the manifold 24 flows vertically downward from the isolation damper location, which is elevated with respect to the base of the filter compartments. An inlet 32 (FIG. 4) at the base of each filter compartment 22a,d remains open with a direct vertical path to a collection hopper 34 to separate a portion of the entrained particles from the dirty gas flow by gravity prior to the full particulate load reaching filter tubes which extend vertically within the filter compartments as shown in FIG. 5. Thus, to remove an individual filtration compartment 22a, for example, isolation damper 30a must be closed thereby removing one fourth of the filtration capacity of the entire filtration plant 20.

These and other aspects and attributes of the present invention will be discussed with reference to the following drawings and accompanying specification.

### BRIEF DESCRIPTION OF THE DRAWINGS

FIG. 1 is a schematic view of a prior art low particulate load filtration plant;

FIG. 2 is an elevation view taken along line A-A of FIG. 1;

FIG. 3 is a schematic view of a prior art high particulate load filtration plant;

FIG. 4 is an elevation view taken along line A-A of FIG. 3;

FIG. 5 is a perspective view partially disassembled of a low particle load filtration plant;

FIG. 6 is a side view of a cleaning mechanism for the filter tubes;

FIG. 7 is a top plan view of the gas filtration plant of FIG. 5;

FIG. 8 is a side view taken along line A-A of FIG. 7;

FIG. 9 is an end view taken along line B-B of FIG. 7;

FIG. 10 is a side view of a gas filtration plant with a circulating bed scrubber; and

FIG. 11 is an end view partially cut away of a gas filtration plant.

### DETAILED DESCRIPTION OF THE INVENTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

The present invention provides a gas filtration unit 100 for collection of dust from industrial applications and particulate (smoke) from coal fired boiler applications. The gas filtration unit 100 is capable of processing high gas flow rates in excess of 30,000 actual cubic feet of gas per minute. The filter units are capable of removing sufficient particulate material, smoke, dust and optionally sulfur dioxide to be discharged into the environment within the legal limits set by the Environmental Protection Agency and other federal and state laws governing such matters.

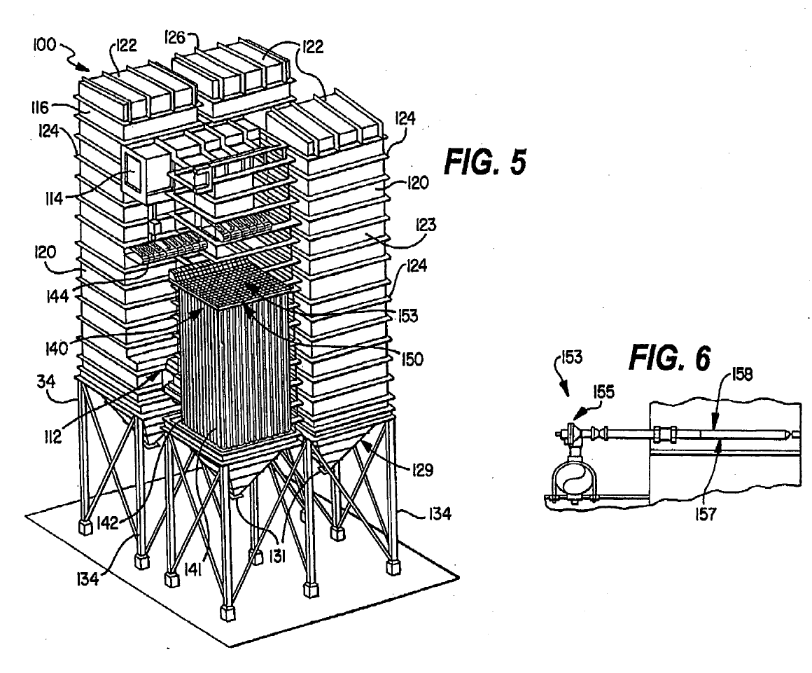

FIG. 5 shows the gas filtration plant 100 having a gas inlet manifold 112, a gas outlet manifold 114 and four gas filter assemblies 116 in fluid communication with the gas inlet and outlet manifolds 112, 114. Four gas filter assemblies 116 are shown but it should be understood that a fewer or a greater number could be provided such as from two to twenty without departing from the invention. The term “plurality” used herein is meant to refer to a number greater or equal to two.

Each gas filter assembly 116 has an outer wall 120 defining a vertically extending tube having a generally square or rectangular shape in horizontal cross section and a top wall 122 closing a top of the tube. It should be understood the outer wall 120 could have other cross-sectional shapes such as circular, oval, polygonal or irregular without departing from the scope of the present invention. The outer wall 120 has a plurality of support bands 124 extending about the periphery of the wall and vertically spaced from one another. The top wall has a plurality of support bands 126 extending along a top surface and lateral sides of the top wall and horizontally spaced from one another. The outer wall 120 and top wall 122 define a chamber 123 therein. The support bands 124 support the outer wall from damage, such as imploding or exploding, from severe pressure changes that occur within the chamber 123 during operation of the filter unit as compared to the ambient conditions outside the chamber 123.

The outer wall 120 has four generally triangular-shaped surfaces that taper 128 axially inwardly and downwardly to define a generally downwardly extending pyramidal-shaped bottom end section 129. The end section terminates in an opening 130 sealed by a closure member 131. The bottom end section 129 defines a particulate collection hopper 132 therein in fluid communication with the chamber 123. The closure member 131 is moveable from a closed position to an open position where cumulated particulate material can be withdrawn from the hopper 132. The filter assemblies 116 are supported and elevated by surface engaging legs 134 attached to the filter assemblies 116 to provide an area underneath the hopper 132 for personnel and equipment necessary to collect and remove the particulate from the filter units.

A filter unit is positioned within the chamber 123 to remove particulate material from the gas flow. In one preferred form of the invention, the filter unit has a plurality of vertically extending, elongate filters 140 and more preferably the filters 140 are in the form of tubes tubes 141 having an inner conduit through which pressurized air flows and having a first end 142 in fluid communication with the inlet manifold 112 and the second end 144 is in fluid communication with the outlet manifold 114. The filter tubes 141 are preferably arranged in an array having a first plurality of columns of tubes and a second plurality of rows of tubes. The first plurality and the second plurality can be equal numbers or can be different numbers and preferably the first plurality and the second plurality are within a range of from 2 to 50, more preferably 4 to 25 and most preferably 6 to 15. In a most preferred form of the invention there are fifteen rows and fifteen columns of filter tubes.

The filter tubes are suspended from a horizontally extending cell plate 150 seal welded to the inner wall of the compartment 120. The filter tubes are held in an open position by internal wire cages not shown. The filter tubes 141 are effective in removing particulate material from a particulate laden flow of gas that is delivered under pressure through the inlet manifold 112 and having a first quantity of particulate material to the first end 142 of the filter tubes, the particulate laden flow of gas flows through the tube and exits the tube through the second end with a second quantity of particulate material. The second quantity of particulate is substantially reduced from the first quantity and by an amount of 95%, more preferably 98% and most preferably 99% or greater.

In a preferred form of the invention the filter material is a fabric material, and more preferably a woven or felted material. Suitable woven material includes any fibrous material and even more preferably a fibrous material containing fibers of a long-chain polysulfide containing material. One suitable type of long-chain polysulfide fiber is polyphenylene sulfide (PPS) formed by the reaction of sulfur with dichlorbenzene followed by extrusion by melt spinning to form fibers or filaments. Woven fiberglass is an example of another acceptable woven material. Suitable felted materials include polytetrafluoroethylene (TEFLON®) felted material, polyimide felt, polyester felt, acrylic felt or other suitable woven or felted material well known to those skilled in the art.

During operation of the filter unit particulate material collects on the filter tubes. Excess particulate material must be removed from the tubes to maintain an acceptable gas pressure and flow rate through the tubes. Accordingly, a cleaning mechanism 153 is associated with each filter unit and the cleaning mechanism is preferably positioned proximate the second end of the filter tubes 144 and even more preferably connected to the frame 150. (See FIGS. 5 and 6) In one preferred form of the invention the cleaning mechanism includes a valve 155 for controlling the flow of pressurized air through a blow tube 157. One valve 155 and blow tube 157 assembly will be associated with either each row or each column of the filter tube array. The valve 155 is connected to a source of pressurized air and is moveable from a closed position where no air flows into the blow tube 157 to an open position where air is supplied under pressure through the blow tube 157.

The blow tube 157 has a plurality of exit holes 158 axially spaced along a length of the tube and having one of each hole associated with either each column or row of the array. In a preferred form of the invention the blow tube 157 is tuned which means that the diameter of the holes 158 are smaller at a proximal end nearest the valve 155 and increase in diameter with increasing distance from the valve 155 to ensure that an approximate equal velocity of air is delivered from each hole regardless of its axial distance from the valve. The exit holes 158 of the blow tube 157 are positioned above the second end 144 of each of the filter tubes and when the valve 157 is opened pressurized air flows downward through the filter tubes 141 and is effective in moving the filter tubes in a manner that shakes excess particulate from the filter tubes. The particulate material falls downward into the hopper 142 where it cumulates. The cleaning mechanism can be operated in various manners including opening and closing each valve one at a time, or by opening more than one valve at a time. In a most preferred form of the invention one valve is opened and closed at a time before opening and closing a second valve and this process is repeated until all of the valves have been opened and closed and then the process starts over again.

Thus, the dirty, particulate laden gas flows from the inlet manifold 112, into the first end of the filter tubes 142, upward through the filter tubes where particulate is removed by the filter tubes and clean air exits from the top of the filter tubes. The clean air is removed from the chamber by the outlet manifold 114 where it can be vented to the environment or used for other purposes.

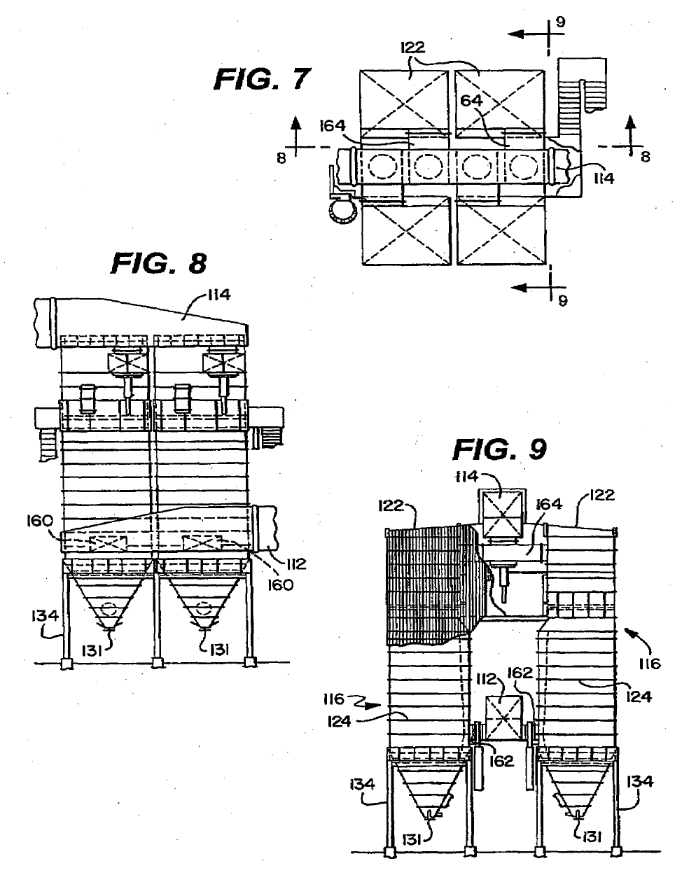

FIGS. 7-9 show the inlet manifold and outlet manifold 112, 114 extending in a first direction between two opposed lines of horizontally spaced filter units. Branches 160 from the inlet manifold extend in a second direction transverse to the first direction and individually supply a gas inlet 162 of each filter unit. Similarly, branches 164 from the outlet manifold extend in a third direction transverse to the first direction and individually remove clean gas effluent from each filter unit 116 and direct it to the outlet manifold.

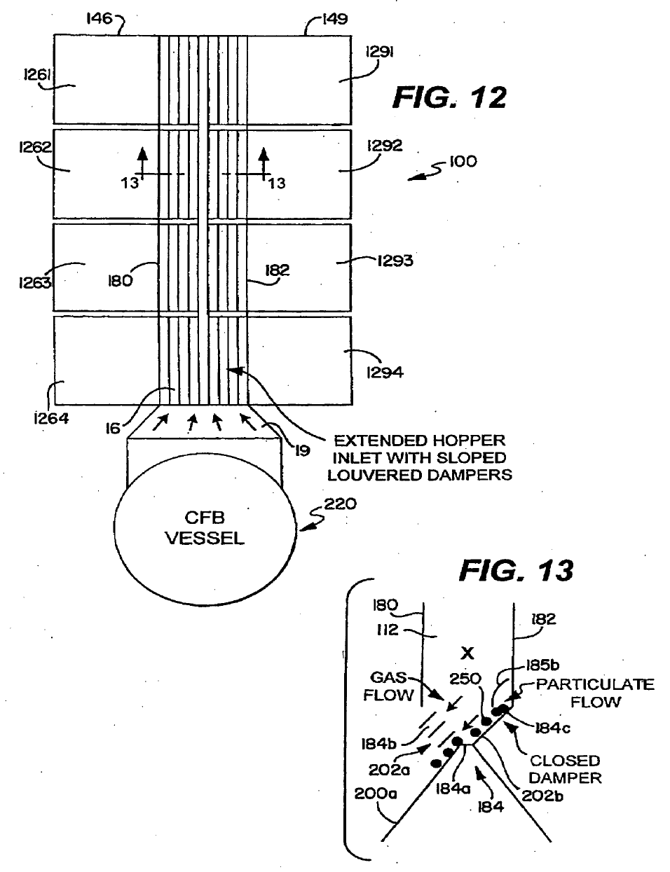

As shown in FIGS. 11 and 13, the inlet manifold 112 has opposed first and second vertically extending sidewalls 180, 182 and a generally horizontally extending segmented bottom wall 184. The segmented bottom wall 184 has three segments, a bottom-most first segment 184a, a second segment 184b connecting a first lateral edge of the first segment to a bottom portion of the first sidewall 180, and a third segment 184c connecting a second lateral edge of the first segment 184a to a bottom portion of the second sidewall 182. The second segment 184b forms a first acute angle 185a with a planar surface 186 of the first sidewall 180 and the third segment 184c forms a second acute angle 185b with a planar surface 188 of the second sidewall 182. The first acute angle and the second acute angle can be of equal value or of different values and the magnitude of the angles do not take into account whether the angle is a positive angle or a negative angle. Each of the first acute angle and the second acute angle should be from about 15 degrees to 85 degrees and more preferably from 35 degrees to 65 degrees and most preferably 55 degrees. In a most preferred form of the invention the first acute angle 185a and the second acute angle 185b are of relatively equal magnitude.

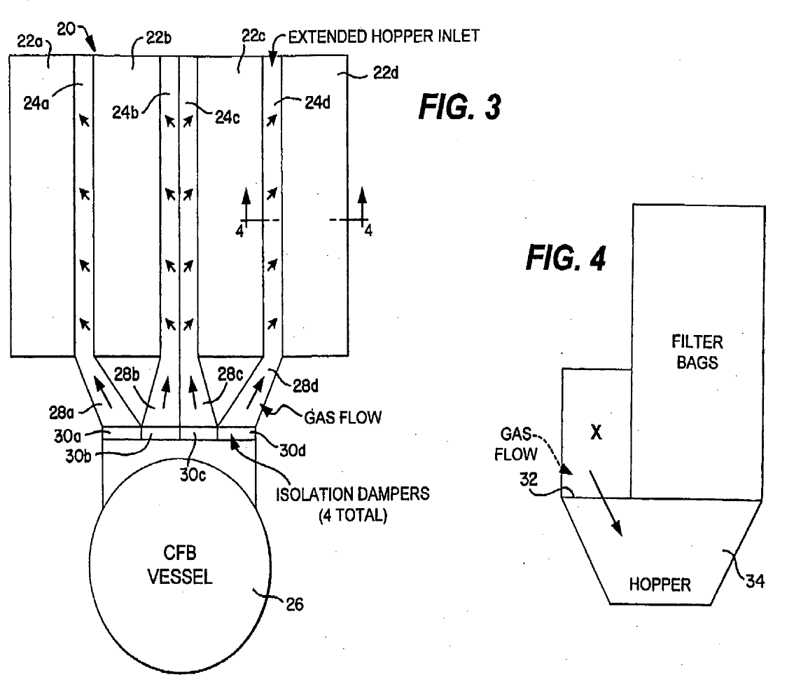

FIGS. 11 and 13 also show a closure members 200a,b positioned over an openings 202a,b in the second and third segments 184b,c of the bottom wall. The openings 202a,b define a fluid inlet into their respective filter unit. Each filter unit has a corresponding inlet and a corresponding closure member. Each closure member can be independently operated so that one filter unit can be removed from service at a time unlike prior art systems, such as shown in FIGS. 3 and 4 which requires that an entire series of filter units associated with a single inlet manifold be taken out of operation simultaneously. The present invention provides an independently operable closure member for each filter unit, and, therefore, filter units can be taken out of service one at a time and independently of one another.

The closure members 200a,b are capable of being moved from an opened position (FIG. 13 shows closure member 202a open and 202b closed) where dirty gas can flow into the filter unit and up through the filter tubes and to a closed position where the closure members 200a,b block the flow of dirty air into their respective filter units. The closure member must be capable of blocking the flow of pressurized air when in a closed position and allowing the flow of air in an open position and in one form of the invention the closure member is a louvered-type closure member having numerous generally rectangular shaped, and spaced slats that when in the closed position the lateral edges of each slat are in contact with a lateral edge of an adjacent slat to form a air tight, generally flat outer surface. To move the closure member to an open position the slats are rotated about their axes to form open channels between adjacent slats to allow dirty air to flow through the closure member and into the filter units. The closure member can take on other forms such as a hinged door or can be a valve such as a butterfly valve, a gate valve, a sliding gate valve, rotating plate valve, check valve or similar valve.

When the closure member 200a is in a closed position as shown in FIG. 11 to allow for servicing of a filter unit, an outlet closure valve 210 is also moved to a closed position to stop the flow of air from the top of the filter tubes into the outlet manifold to equalize the pressure across the filter tubes. The outlet closure valve 210 is, in a preferred form of the invention, a poppet valve. However, other valves could be used without departing from the scope of the present invention. As shown in FIG. 13 when the second closure member 202b is in the closed position particulate material 250 (FIG. 13) that drops from the dirty air cumulates on the bottom wall. Since the closure member is placed on the third segment of the bottom wall the cumulating particulate material is directed toward the opposed open closure member 200a, and, therefore, the cumulating particulate material is not allowed to place an undue burden on the closure member 200b which can lead to premature failure of the closure member 200b which in turn can require repair of the closure member.

When the closure member 200b is in the open position as shown in FIG. 11, dirty air is allowed to flow downwardly in the direction of the arrow 201 into the hopper and then upwardly through the filter tubes. The dirty air flow is required to change directions thereby substantially decreasing the flow rate of particulate when compared to the flow rate through the inlet manifold. The flow rate of dirty gas entering the filter tubes is reduced from is flow rate of from around 3200-3600 ft/min rate through the inlet manifold to about 500 ft/min or less rate as the dirty gas flow enters the hopper. Consequently, much of the particulate material that is entrained in the dirty gas flow drops out and cumulates in the hopper instead of traveling up through the filter tubes. Thus, the filter tubes can be kept in operation over a longer period of time, and the filter tubes do not have to be cleaned as frequently as they would have to be if the dirty gas flow rate was not reduced.

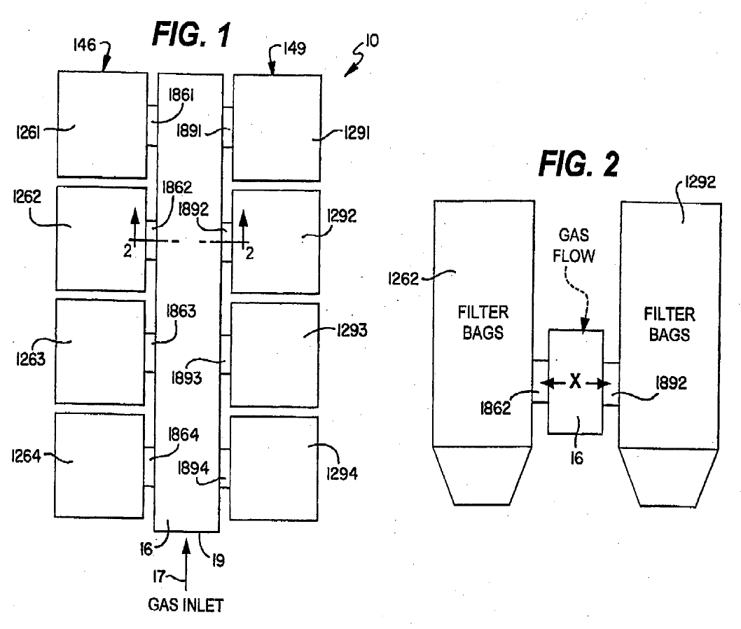

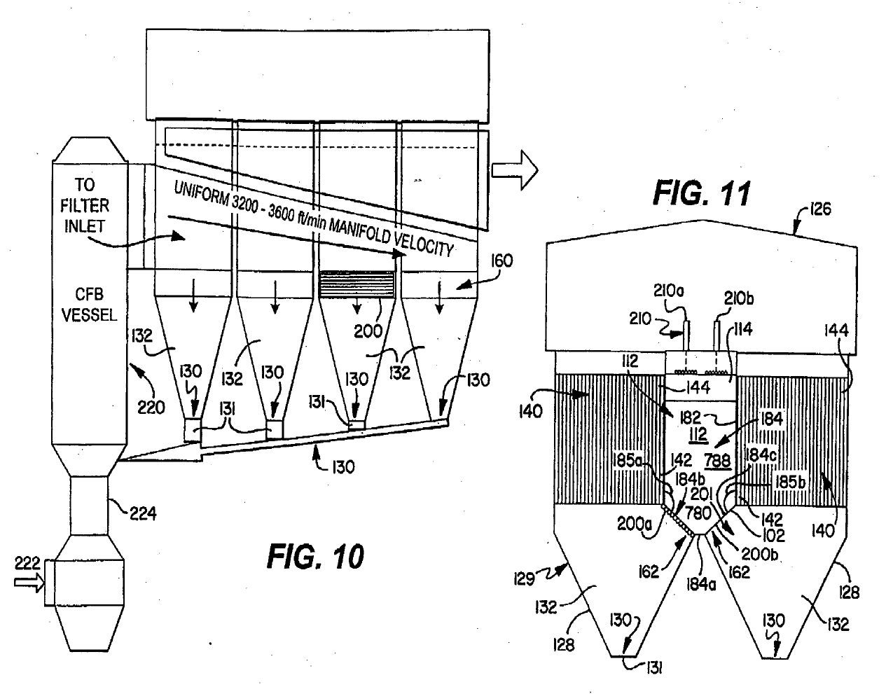

FIGS. 10, 12 and 13 show a filter plant 100 of the present invention with a configuration of filter units similar to the low particle design of FIG. 1 but having an optional circulating fluid bed scrubber (CFB) 220 which is used to reduce the quantity of sulfur dioxide contained in the dirty gas flow. Otherwise, like numerals will be used to refer to like parts of FIG. 1. The CFB has an inlet 222 for receiving the dirty gas flow and a venturi section 224 for increasing the velocity of the dirty gas flow to keep the particulate material entrained in the dirty gas flow. Upstream of the venturi section 224 the dirty gas enters a chamber where it is subjected to a pressurized stream of hydrated lime, pressurized water spray, re-circulated ash and lime from the hoppers provided through a recirculation line 230 that is in fluid contact with each of the hoppers. The lime or calcium hydroxide reacts with sulfur dioxide to form calcium sulfite and calcium sulfate. The pressurized water spray drives this reaction forward by cooling the gas through evaporation of the water. Due to the use of particulate material such as ash and lime, the dirty gas experiences a substantial increase in the quantity of particulate material entrained in the dirty gas flow. The quantity of particulate material can reach as high as 500 grains mass/ft³. Accordingly, the reduction in the dirty gas flow rate to cause the substantial particulate drop out into the hopper discussed above is significant and important particularly when using the optional CFB.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims

What is claimed is:

1. A gas filtration plant for removing particulate material from a pressurized stream of dirty air comprising:
a first filter assembly defining a first chamber having a first inlet, a first outlet and a first filter unit positioned in the chamber between the first inlet and the first outlet;
a second filter assembly defining a second chamber having a second inlet, a second outlet and a second filter unit positioned between the second inlet and the second outlet; and
an inlet manifold having a first sidewall and a second sidewall opposed to the first sidewall and a segmented bottom wall extending between the first sidewall and the second sidewall, the segmented bottom wall having a bottom-most first segment, a second segment connecting the first segment to the first sidewall, a third segment connecting the first segment to the second sidewall, the second segment forming a first acute angle with the first sidewall and the third segment forming a second acute angle with the second sidewall, the inlet manifold extending between the first filter assembly and the second filter assembly, the first filter assembly being positioned adjacent the first sidewall and the second filter assembly being positioned adjacent the second sidewall, the inlet manifold being capable of directing a pressurized particulate-containing gas flow defining a dirty gas flow to the first inlet and the second inlet.

2. The gas filtration plant of claim 1 further comprising a first member for closing the first inlet and a second member for closing the second inlet, the first member and the second member being moveable among four configurations, the first configuration having the first member in an open position and the second member in an open position, a second configuration having the first member in a closed position and the second member in an open position, a third configuration having the first member in an open position and the second member in a closed position, and a fourth configuration having the first member is a closed position and the second member in a closed position.

3. The gas filtration plant of claim 2 wherein the first member is positioned on the second segment.

4. The gas filtration plant of claim 3 wherein the second member is positioned on the third segment.

5. The gas filtration plant of claim 3 wherein when the first member and the second member are in the second configuration the first member is capable of directing cumulated particulate material into the second inlet.

6. The gas filtration plant of claim 2 wherein the first acute angle is from 15 degrees to 85 degrees.

7. The gas filtration plant of claim 2 wherein the first acute angle is from 35 degrees to 65 degrees.

8. The gas filtration plant of claim 6 wherein the second acute angle is from 15 degrees to 85 degrees.

9. The gas filtration plant of claim 6 wherein the absolute value of second acute angle is equal to the first acute angle.

10. The gas filtration plant of claim 1 wherein the first filter unit comprises a first plurality of filters arranged in a first array having a first number of aligned rows of elongate filters and a second number of aligned columns of elongate filters.

11. The gas filtration unit of claim 10 further comprising a cleaning mechanism positioned within the first chamber for removing particulate material from the first plurality of filters.

12. The gas filtration unit of claim 10 wherein the first plurality of filters are fabric filters.

13. A method for filtering particulate material from a pressurized stream of dirty air comprising:
directing a stream of air under pressure through an inlet manifold, the air containing a first quantity of particulate material entrained therein to define a dirty gas flow, the inlet manifold having a first sidewall, a second sidewall opposed to the first sidewall and a segmented bottom wall, the segmented bottom wall having a bottom-most first segment, a second segment connecting the first segment to the first sidewall and forming a first acute angle with the first sidewall, and a third segment connecting the first segment with the second sidewall and forming a second acute angle with the second sidewall;
guiding a first portion of the dirty gas flow into a first filter assembly, the first filter assembly defining a chamber having a first inlet, a first outlet and a first filter unit in the first chamber and positioned between the first inlet and the first outlet;
guiding a second portion of the dirty gas flow into a second filter assembly spaced from the first filter assembly, the second filter assembly defining a second chamber having a second inlet, a second outlet and a second filter unit in the second chamber and positioned between the second inlet and the second outlet
controlling the flow of dirty air into the first filter assembly with a first damper moveable from a first position where dirty air can flow into the first inlet, to a second position where dirty air cannot flow into the first inlet, the first damper being positioned over an opening through the first segment;
controlling the flow of dirty air into the second filter assembly with a second damper moveable from a first position where dirty air can flow into the second inlet, to a second position where dirty air cannot flow into the second inlet, the second damper being positioned over an opening through the third segment; and
closing the first damper to block the flow of dirty air into the first inlet and to direct particulate material cumulated proximate the first damper into the second inlet.

14. The method of claim 13 wherein the first acute angle and the second acute angle are in the range of from 15 degrees to 85 degrees.

15. The method of claim 13 wherein the first filter unit comprises a first plurality of filters arranged in a first array having a first number of aligned rows of elongate filters and a second number of aligned columns of elongate filters.

16. The method of claim 15 further comprising a cleaning mechanism positioned within the first chamber for removing particulate material from the first plurality of filters.

17. The method of claim 16 wherein the first plurality of filters are fabric filters.

18. The method of claim 17 wherein the fabric is a woven material or a felted material.

19. The method of claim 18 wherein the woven material is selected from the group consisting of a polyphenylene sulfide and fiberglass.

20. The method of claim 18 wherein the felted material is selected from the group consisting of polytetrafluoroethylene felt, polyimide felt, polyester felt, and acrylic felt.
